(19) United States
(12) Patent Application Publication
(10) Pub. No.: US 2008/0298746 A1
(43) Pub. Date: Dec. 4, 2008

(54) Optical Fiber Side Coupler for Coupling Light Between a Multimode Optical Fiber and a Cladding Pumping Optical Fiber

(76) Inventors: Nigel Holehouse, Saint Lazare (CA); Peter Rainville, Granby, CT (US)

Correspondence Address: NUFERN;Peter J. Rainville, 7 AIRPORT PARK ROAD, EAST GRANBY, CT, 06026, US

(21) Appl. No.: 12/133,276

(22) Filed: Jun. 4, 2008

Related U.S. Application Data
(60) Provisional application No. 60/941,922, filed on Jun. 4, 2007.

(51) Int. Cl. G02B 6/26

(52) U.S. Cl. 385/43

(57) ABSTRACT

An optical fiber side coupler apparatus comprising a first optical fiber and at least one multimode (MM) optical fiber having a core, the MM optical fiber for delivering light to the first optical fiber. The MM optical fiber can comprise a first length having a first location therealong wherein the core comprises a first cross sectional area A₁, a second length having a second location therealong wherein the core comprises a second cross sectional area A₂ that is less than the first cross sectional area A₁, and a transition section, located between the first and second locations, wherein the cross sectional area of the core of the MM optical fiber is reduced. The second length can be secured alongside a selected length of the first optical fiber so as to provide optical coupling between the MM optical fiber and the first optical fiber. The MM optical fiber can be free of any progressively tapered length secured with the first optical fiber in a manner that would provide substantial optical coupling between the MM optical fiber and the first optical fiber.

### CROSS-REFERENCE TO RELATED APPLICATION

This application claims priority to provisional patent application 60/941,922, filed Jun. 4, 2007 and entitled, “Optical Fiber Side Coupler for Coupling Light Between a Multimode Optical Fiber and a Cladding Pumping Optical Fiber”, and which is herein incorporated by reference.

### FIELD OF THE INVENTION

The present invention relates to optical fiber couplers and, more particularly, to an optical fiber side coupler for coupling light between a multimode optical fiber and another optical fiber.

### BACKGROUND

Optical fiber couplers are known in the art. See, for example, the following US Patents: U.S. Pat. No. 4,815,079, issued Mar. 21, 1989 to Snitzer et al. and entitled “Optical Fiber Lasers and Amplifiers”; U.S. Pat. No. 4,818,062, issued Apr. 4, 1989 to Scifres et al. and entitled “Optical System with Bright Light Output”; U.S. Pat. No. 5,864,644, issued Jan. 26, 1999 to DiGiovanni et al. and entitled “Tapered Fiber Bundles for Coupling Light Into and Out of Cladding-Pumped Fiber Devices”; U.S. Pat. No. 5,999,673 issued Dec. 7, 1999 to Gapontsev et al. and entitled “Coupling Arrangement Between a Multi-Mode Light Source and an Optical Fiber Through an Intermediate Optical Fiber Length”; U.S. Pat. No. 6,434,302, issued Aug. 13, 2002 to Fidric et al. and entitled Optical Couplers for Multimode Fibers; U.S. Pat. No. 6,434,295 issued Aug. 13, 2002 to MacCormack et al. and entitled “Side Coupled Pumping of Double Clad Fiber Gain Media”; U.S. Pat. No. 6,823,117, issued Nov. 23, 2004 to Vakili et al. and entitled “Mode Multiplexing Optical Coupling Device”; U.S. Pat. No. 6,826,335, issued Nov. 30, 2004 to Grudinin et al. and entitled “Multi-Fibre Arrangements for High Power Fibre Lasers and Amplifiers”; U.S. Pat. No. 7,046,432, issued May 16, 2006 to Starodoumov and entitled “Optical Fiber Coupling Arrangement”; and U.S. Pat. No. 7,046,875, issued on May 16, 2006 to Gonthier et al. and entitled “Optical Coupler Comprising Multimode Fibers and Method of Making the Same. See also PCT Application PCT/IL2004/000512, published on Dec. 23, 2004 as WO2004/112206 in the name of Yoav Sintov and entitled “Optical Apparatus”.

Although one or more of the foregoing patents may teach one or more useful optical fiber couplers, drawbacks and disadvantages remain. Accordingly, it is an object of the present invention to address one or more of the foregoing disadvantages and drawbacks of the prior art.

### SUMMARY OF THE INVENTION

In one aspect, the invention provides an optical fiber side coupler apparatus, comprising a first optical fiber and at least one multimode (MM) optical fiber having a core. The MM optical fiber can deliver light to the first optical fiber, and the MM optical fiber can comprise a first length having a first location therealong wherein the core comprises a first cross sectional area A₁ and a second length having a second location therealong wherein the core comprises a second cross sectional area A₂ that is less than the first cross sectional area A₁. The MM optical fiber can also include a transition section, located between the first and second locations, wherein the cross sectional area of the core of the MM optical fiber is reduced. The second length can be secured alongside a selected length of the first optical fiber so as to provide optical coupling between the MM optical fiber and the first optical fiber. The MM optical fiber can be free of any progressively tapered length secured with the first optical fiber in a manner that would provide substantial optical coupling between the MM optical fiber and the first optical fiber.

In other aspects of the invention, the transition section can comprise a length of the MM optical fiber wherein the core thereof comprises a progressive taper. The MM optical fiber can comprise a third length having a third location therealong wherein the core comprises a third cross sectional area A₃ that is less than the first cross sectional area A₁. The third length can be secured alongside the first optical fiber for providing optical coupling between the MM optical fiber and the first optical fiber. The third cross sectional area A₃ is less than the second cross sectional area A₂. The optical fiber side coupler apparatus can comprise a second transition section located between the second locations and the third locations wherein the second transition section can comprise a length of the MM optical fiber wherein the core thereof comprises a progressive taper. The optical fiber side coupler apparatus can comprise a second transition section located between the second location and the third location wherein the second transition section is adapted for converting energy from lower order modes of the MM optical fiber to higher order modes of the MM optical fiber. The second transition can include at least one of an up taper and a down taper. The second transition can include both an up taper and a down taper. The cross sectional area of the core of the MM optical fiber can remain substantially the same along the second length. The second length can comprise a diameter that remains substantially the same along the second length.

In additional aspects of the invention, at least a part of one of the MM and first optical fibers can be wound together with at least a part of the other of the optical fibers. At least one of the second length of the MM optical fiber and the selected length of the first optical fiber can be wound together with the other of the second length of the MM optical fiber and the selected length of the first optical fiber.

In further aspects of the invention, the MM optical fiber can include an input end and an output end. Alternatively, the MM optical fiber can comprise only an input end. The first optical fiber can comprise an input end and an output end and the second length of the MM optical fiber can be secured alongside the selected length of first optical fiber at a location between the input and output ends of the first optical fiber. The MM optical fiber can have an input end and the optical fiber side coupler apparatus can further comprise a light source optically coupled with the input end so that light having a selected brightness is propagated by the MM optical fiber. The fiber optic side coupler apparatus can be arranged such that along the second length the product of the numerical aperture (NA) of the core of the MM optical fiber and the cross sectional area of the core does not exceed the selected brightness.

In yet other aspects of the invention, the first optical fiber can comprise a diameter that is substantially the same along the selected length. The first optical fiber can comprise a cladding pumping optical fiber having a core, an inner cladding disposed about the core and an outer cladding disposed about the inner cladding. The outer cladding of the first optical fiber can be not present along at least part of the selected length thereof and the cladding of the MM optical fiber can be not present along at least part of the second length thereof. The inner cladding of the first optical fiber can comprise an outer diameter D_{IC} of the inner cladding and the core of the first optical fiber can have a diameter D_{CoreCP}. The first optical fiber can comprise a ratio (D²_{IC}/D²_{CoreCP}) of at least 25 at least at a location along a length of the first optical fiber other than a location along the selected length of the first optical fiber. The ratio can also be at least 25 at a location along the selected length of the first optical fiber. The MM optical fiber can comprise a cladding disposed about the core of the MM optical fiber. The core of the MM optical fiber can comprise a diameter D_{CoreMM} and the cladding of the MM optical fiber can have a diameter D_{CladMM}, and at least at a location along the first length of the MM optical fiber the ratio of (D²_{CladMM}/D²_{CoreMM}) is no greater than 1.75. In one variation, at least along the first length, the core of the first optical fiber has a NA of no greater than about 0.09 and a diameter of at least 15 microns for providing a fundamental mode having an increased mode field diameter. At least along the first length, the core of the first optical fiber can have a V-number of greater than 2.5 for light having a wavelength of 1 micron.

In yet further aspects of the invention, the second length of the MM optical fiber can be secured alongside the selected length of the first optical fiber by being fused to the selected length of the first optical fiber. The second length of the MM optical fiber can be secured alongside the selected length of the first optical fiber by being bonded with the selected length using an adhesive.

The term “light” as used herein, means, as understood by one of ordinary skill in the optical arts, the electromagnetic energy associated with the optical apparatus in question, and is not to be limited to, for example, wavelengths visible to the human eye, which is a definition that can be found in certain dictionaries intended for laypersons.

Stating herein that an optical fiber, for example, has “a first length having a diameter that is substantially the same” refers to a diameter as a function of the first length. The optical fiber, need not, when viewed in a cross section taken perpendicular to the first length, have a diameter that is substantially the same for all azimuthal angles (e.g., have a circularly shaped cross section). It is well known for an optical fiber to have a region having a non-circular cross section. For example, the inner cladding of a cladding pumping optical fiber is typically constructed so as to have a non-circular cross section to enhance the intersection of pump light with the core of the optical fiber. The inner cladding can have, for example, a D-shape. However, the D-shape can have a diameter that is substantially the same along the first length.

Furthermore, as understood by one of ordinary skill in the art, in light of the disclosure presented herein, there are statistical process variations associated with the manufacture of all articles. Optical fibers are no exception. Accordingly, specifying herein that a length of optical fiber has a diameter that is substantially the same is intended to allow for deviations acceptable for the fabrication process involved or accepted by those of ordinary skill in the art. Certain processes can be more difficult than others, or certain regions of an optical fiber can be more difficult to fabricate than others, and accordingly larger variations are known and accepted as being associated therewith.

“Multimode optical fiber”, as that term is used herein, means that at least the next highest mode from the fundamental LP mode of the optical fiber is not cutoff at the operating wavelength of the optical fiber and hence propagates. For a step index optical fiber or an optical fiber having an equivalent step index, a normalized frequency, or V-number, of greater than 2.405, can indicate that the optical fiber is multimode. For such an optical fiber having a round core, V-number=[(π)×(core diameter)×(core NA)]/[free space operating wavelength]. “Optical fiber”, as used herein, can include lengths of optical fiber spliced or otherwise optically coupled together. The term “progressive taper” means a smooth (as opposed to a discontinuous change, such as “step” change) monotonic reduction in the cross sectional area of a region of the optical fiber with distance along the elongate, or longitudinal, axis of the optical fiber, such as is produced by the heating and drawing process well known to those of ordinary skill in the art of fiber optic coupler manufacture.

### BRIEF DESCRIPTION OF THE DRAWINGS

FIG. 1 schematically illustrates a cross section of an optical fiber side coupler apparatus in according to one embodiment of the present invention;

FIG. 2 is a cross section taken along section line 2-2 of FIG. 1;

FIG. 3 is a cross section taken along section line 3-3 of FIG. 1;

FIG. 4 schematically illustrates in additional detail the second transition section 40 of FIG. 1; and

FIG. 5 schematically illustrates a cross section of one embodiment of an optical fiber side coupler in which one of the optical fibers of the side coupler is wound with the other of the optical fibers of the optical fiber side coupler.

### DETAILED DESCRIPTION

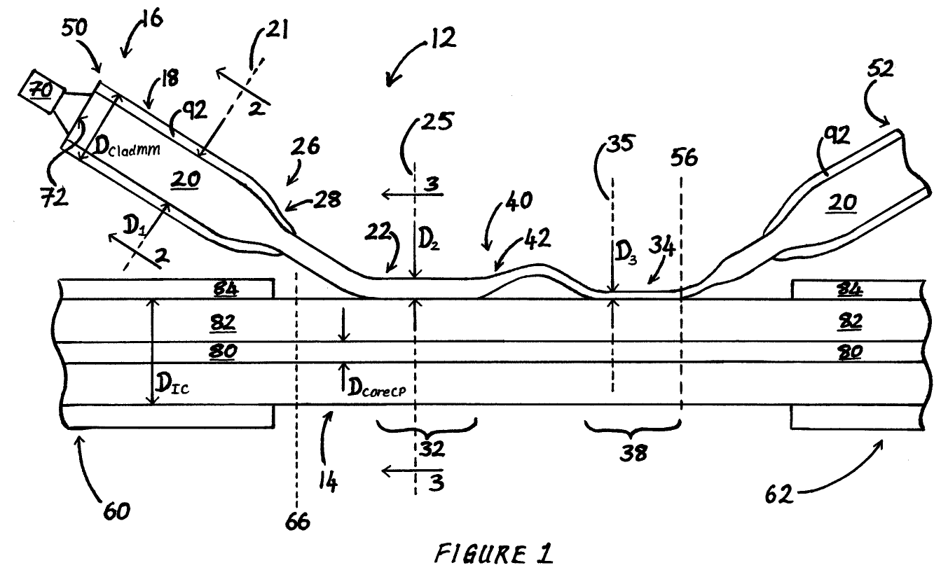

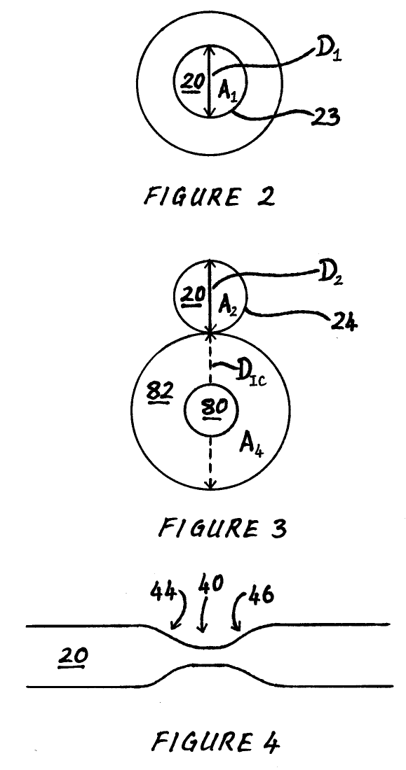

FIG. 1 schematically illustrates an optical fiber side coupler apparatus 12 according to one embodiment of the present invention. The optical fiber side coupler apparatus 12 can comprise a first optical fiber 14 and at least one multimode (MM) optical fiber 16 for delivering optical energy from the MM optical fiber 16 to the first optical fiber 14. The MM optical fiber 16 can include a first length 18. The MM optical fiber 16 can have a core 20 that has a diameter D₁ and a cross sectional area A₁ at a first location along the first length 18, such as at the location indicated by reference numeral 21. FIG. 2 is a cross section of the MM optical fiber 16 taken along section line 2-2 at location 21 and shows the cross sectional area A₁ of the core 20 and the perimeter 23 of the core 20.

Additionally, the cross sectional area A₁ and/or the diameter D₁ can remain substantially the same along the first length 18. The cross-sectional area remaining substantially the same can include, but does not require, the diameter D₁ remaining substantially the same along the first length 18 and/or the cross-sectional shape of the core 20, defined by its outer perimeter 23, remaining substantially the same along the first length 18. In the embodiment shown in FIGS. 1 and 2, the core 20 does comprise a diameter and cross sectional shape (circular) that is substantially the same along the first length 18. As shown in FIG. 1, the length 18 of the MM optical fiber 16 can be substantially free of a progressive taper.

The MM optical fiber 16 can also comprise a second length 22. A region, such as the core 20, of the MM optical fiber 16 can comprise a diameter D₂ and have second cross sectional area A₂ at a second location along the second length, such as at the location indicated by the dotted line 25. Reference is made to FIG. 3, which is a cross section taken along section line 3-3 of the optical fiber side coupler of FIG. 1. The cross sectional area of the core 20 can be substantially the same along the second length 22, though, as noted above, neither a diameter of the core nor the cross sectional shape of the core 20 need be substantially the same along the length 22.

The second length 22 can be secured alongside a selected length 32 of the first optical fiber 14 so as to provide optical coupling between the MM optical fiber 16 and the first optical fiber 14. The cross sectional area A₂ can be, and typically is, less than the cross sectional area A₁, so as to increase the coupling of energy from the MM optical fiber 16 to the first optical fiber 14. Coupling between the MM optical fiber 16 and the first optical fiber 14 generally increases as the cross sectional area of the MM optical fiber 16 (e.g., the cross sectional area A₂ shown in FIG. 3), becomes smaller relative to the cross sectional area of the first optical fiber 14 (e.g., the cross sectional area A₄ shown in FIG. 3), where the optical fibers are secured alongside each other for coupling. See, for example, FIG. 3, showing the cross sectional area A₂ relative to the cross sectional area A₄ of the first optical fiber at the location 25.

The optical fiber side coupler apparatus 12 can include a transition section 26 located between the first and second locations 21 and 25. The transition section 26 can include a length, such as the progressively tapered length 28, along which a cross sectional area of the MM optical fiber 16, such as the cross sectional area of the core 20, is reduced. The transition section 26 can be adapted for converting energy from lower order modes (which may not couple as readily to the first optical fiber 14), to higher order modes of the MM optical fiber 16 (which may couple more readily), such as by including both a down taper (e.g., the progressive taper noted above) and an up taper (not shown).

In certain practices of the invention, the transition section 26 does not substantially optically couple to the first optical fiber 14, and, for example, the transition section 26 is not secured (e.g., fused) with the first optical fiber 14 in a manner that would provide for substantial optical coupling between the transition section 26 and the first optical fiber 14. The transition section 26 can be free of any progressively tapered length that substantially optically couples to the first optical fiber 14. More generally, in certain practices of the invention, the MM optical fiber 16 can itself be free of any progressively tapered length that substantially couples optical energy to the first optical fiber 14, and, for example, the MM optical fiber 16 does not include a progressively tapered length that is secured, such as by being fused, to the first optical fiber 14 in a manner that would substantially optically couple to the first optical fiber 14. At least one of U.S. Pat. No. 5,999,673 to Gapontsev et al. and the aforementioned PCT publication WO2004/112206 to Sintov are understood to teach a progressively tapered length arranged so as to provide substantial optical coupling.

The MM optical fiber 16 can comprise a third length 34 secured alongside the first optical fiber 14, such as along the second selected length 38, for providing optical coupling between the MM optical fiber 16 and the first optical fiber 14. The third length 34 can be substantially free of a progressive taper. A region, such as the core 20, of the third length 34 of MM optical fiber 16 can comprise a third diameter D₃ and have third cross sectional area A₃ (not explicitly shown) at a location, such as the location indicated by the dotted line 35 along the third length 34. The cross sectional area of the core 20 can be substantially the same along the third length, though, as noted above, the diameter D₃ need not remain substantially the same nor need the shape of the core remain substantially the same along the third length, though one or both of the foregoing can remain substantially the same along the third length 34. The cross sectional area A₃ can be less than the cross sectional area A₁. The cross sectional area A₃ can also be less than the cross sectional area A₂.

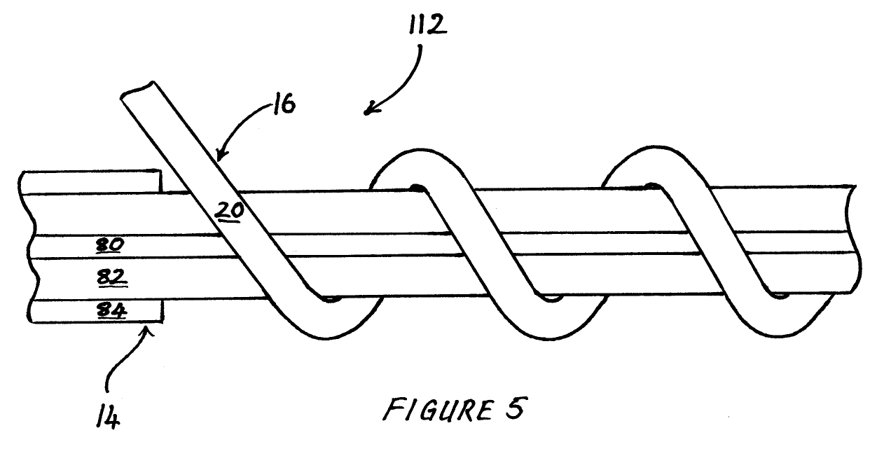

The MM optical fiber 16 can include a second transition section 40 located between the second and third lengths 22 and 34, where the second transition section 40 is not secured with the first optical fiber 14 in a manner that would provide substantial optical coupling between the second transition section 40 and the first optical fiber 14. The second transition section 40 can include a tapered length 42 along which the diameter of a region (e.g., the core) of the optical fiber 14 is reduced. As schematically illustrated in FIG. 4, which is an expanded view of the second transition section 40, the second transition section 40 can include a down taper 44, which can comprise a tapered length of MM optical fiber 16 along which a diameter is reduced. The down taper, can, in certain embodiments, be followed by an up taper 46, which comprises a length of the MM optical fiber 16 along which a diameter is increased, as shown in FIG. 4. A transition region, such as, for example, the second transition region 40 can be adapted for converting energy from lower order modes of the MM optical fiber 16 to higher order modes of the MM optical fiber 16, means that light is converting from having a lower numerical aperture (NA) to having a higher NA. A down taper followed by an up taper (or vice versa) is understood to facilitate the energy from lower order modes to higher order modes, which can facilitate coupling of energy to the first optical fiber 14 from the MM optical fiber 16.

In one practice of the invention, the cross sectional area A₂ is less than the cross sectional area A₁ so as to increase coupling between the MM optical fiber 16 and the first optical fiber 14, but the cross sectional area A₂ is not so small so as to significantly increase undesirable loss of high NA light from the side coupler apparatus 12, which can happen if the brightness of the second length 22 of the MM optical fiber 16 becomes less than that of higher NA light that has not yet coupled to the first optical fiber 14.

Some discussion of brightness may be in order. Without wising to be bound by theory, except to the extent that a theory may be explicitly recited in a claim, brightness is understood to be conserved in passive devices. For an optical fiber, the brightness that can be propagated by the optical fiber without excessive loss of light is the product of the NA and the cross sectional area of the region of the optical fiber propagating the light. Often the light coupled to the optical fiber does not “fill” the NA of the region of the optical fiber propagating the light, such that the brightness of the propagated light is less than the brightness of the light that can be propagated by the optical fiber.

Light will couple more efficiently from one optical fiber to another optical fiber when the one optical fiber has a small cross sectional area relative to the cross sectional area of the other optical fiber. Accordingly, reducing the cross sectional area of the MM optical fiber 16 by reducing the diameter thereof can help effectuate the coupling of light from the MM optical fiber 16 to the first optical fiber 14. However, reducing the diameter also reduces the brightness that can be carried by the reduced diameter section of the optical fiber. If the maximum brightness of the optical fiber exceeds the brightness of some of the light that one is attempting to have the optical fiber propagate, the higher NA light can be lost.

Avoiding the potential loss of higher NA light can impose a limit on how small it is advisable to make A₂, which also means that the lower NA light propagating along the second length 22 may not couple as much as would be desired to the optical fiber 14 along the length 32. Accordingly, the second transition section 40 can be adapted to convert some of the lower NA light to higher NA light, such as by mode scrambling so as to convert energy from lower order modes to higher order modes. Because presumably at least some of the highest NA light initially propagating along the MM optical fiber 16 has been sufficiently coupled to the first optical fiber 14 along the length 32, the diameter A₃ can be smaller than that of A₂ without incurring undue loss of this light from the coupler apparatus 12 and coupling can be enhanced along the length 38, so as, for example, to facilitate coupling of now converted low NA light to the first optical fiber 14.

Preferably the second tapered length 42 is not secured with the first optical fiber 14 in a manner that would provide substantial optical coupling between the second tapered length and the first optical fiber 14.

Many processing techniques suitable for forming optical fiber couplers are well know in the art, including, for example, techniques for reducing the diameter of an optical fiber so as to introduce up or down tapers, progressive tapers, and the like, and fusing or bonding optical fibers. Techniques for reducing the diameter can include heating and drawing one or more optical fibers, with or without winding the optical fibers together, as well as selective etching of an optical fiber or fibers.

In the embodiment of the optical fiber side coupler apparatus 12 shown in FIG. 1, the MM optical fiber 16 includes an input end 50 and an output end 52. However, in an alternative embodiment, the MM optical fiber 16 includes only an input end 50. For example, the MM optical fiber can be terminated at the location indicated by the dotted line 56. Similarly, in the embodiment of the optical fiber side coupler apparatus 12 shown in FIG. 1, the first optical fiber 14 can have an input end 60 and an output end 62 and the second length 22 of the MM optical fiber 16 is secured alongside the selected length 32 of first optical fiber 14 at a location between the input end 60 and the output end 62 of the first optical fiber 14. However, as appreciated by one of ordinary skill in the art, cognizant of the disclosure herein, the first optical fiber need not include an input end, and can, for example, be terminated at the location indicated by the dotted line 66. As is also appreciated by one of ordinary skill in the art, combinations of the foregoing are within the scope of the invention. For example, the MM optical fiber 16 can have only an input end 50 and the first optical fiber 14 can have either both an input end 60 and an output end 62 or can just have an output end 62. Similarly, the MM optical fiber 16 can have both an input end 50 and an output end 52 and the first optical fiber 14 can have either only an only an output end 62 or can have both an input end 60 and an output end 62.

The first optical fiber 14 can comprise a cladding pumping optical fiber having a core 80, an inner cladding 82 disposed about the core 80 and an outer cladding 84 disposed about the inner cladding 82. The MM optical fiber 16 can include a core 20 and a cladding 92 disposed about the core 20. In one practice of the invention, as shown in FIG. 1, the outer cladding 84 of the first optical fiber 14 is not present along the selected length 32 thereof and the cladding 92 of the MM optical fiber 16 is not present along the second length 22 thereof. The core 20 of the MM optical fiber can couple light directly to the inner cladding 82 of the first optical fiber 14, that is, light is not coupled from the core 20 to the inner cladding 82 via a substantial intervening region. In other practices of the invention, one or both of the outer cladding 84 or the cladding 92 are present and coupling occurs via one or both of these regions.

The inner cladding 82 of the first optical fiber 14 can have an outer diameter D_{IC} and the core 80 of the first optical fiber can have a diameter D_{CoreCP}, as indicated in FIG. 1. The optical fiber 14 can comprise a ratio (D²_{IC}/D²_{CoreCP}) of at least 25 at least along a length of the first optical fiber 14, which can be, for example, along a length other than the selected length 32 of the first optical fiber 14. The ratio can be at least 25 along the selected length 32 or can be at least 25 along a length other than the selected length 32 as well as along the selected length 32. Alone or in combination with the foregoing ratio, the core 20 of the MM optical fiber 16 can comprise a diameter D_{CoreMM}, which can be equal to the diameter D₁ of FIGS. 1 and 2, and the cladding 92 of the MM optical fiber 16 can comprise a diameter D_{CladMM}, as also indicated in FIG. 1. In one practice of the invention, at least along the first length 18 of the MM optical fiber 16 the ratio of (D²_{CladMM}/D²_{CoreMM}) is no greater than 1.75.

Typically core 80 of the first optical fiber 14 has a NA of no greater than about 0.09 and a diameter of at least 15 microns, which can provide a fundamental mode having an increased mode field diameter. Alone or in combination with the foregoing NA and diameter values, the core of the first optical fiber can comprise a V-number of greater than 2.5 for light having a wavelength of 1 micron.

The second length 22 of the MM optical fiber 16 can be secured alongside the selected length 32 of the first optical fiber 14 by being fused to the selected length 32 of the first optical fiber 14. The second length 22 of the MM optical fiber 16 can be secured alongside the selected length 32 of the first optical fiber 14 by being bonded with the selected length 32 using a bonding agent. Use of a bonding agent is taught in, for example, the aforementioned PCT publication WO2004/112206 to Sintov.

As schematically illustrated in FIG. 1, the optical fiber side coupler apparatus 12 can include a light source 70 optically coupled with the input end 50 of the MM optical fiber 16. In the embodiment shown in FIG. 1, the light source 70 is shown as coupled with an end face 72 of the end 50 of the MM optical fiber 16. However, the light source 70 can include a light emitting diode or a laser diode, for example, or a bar or stack arrangement of the foregoing, as is known in the art, or multiple single emitters or bar or stacks. Additionally or alternatively, the light source 70 can include one or more optical elements, such as a lens or the like, positioned between one or more laser diodes and the end of the MM optical fiber 16 for conditioning light, such as to increase the efficiency of light reception by the MM optical fiber 16. The face 72 of the MM optical fiber 16 can be shaped, such as, for example, to include flat or curved surfaces for increasing the efficiency of light reception by the MM optical fiber 16. The light source 70 can include a pigtail that is spliced to the MM optical fiber 16 or that includes one or more laser diode, light emitting diodes or the like that are optically coupled to the MM optical fiber 16 via a tapered fiber bundle (TFB), which is a type of coupler well known in the art (e.g., see, for example, the aforementioned U.S. Pat. No. 6,434,302 to Fidric et al. or a side coupler, such as the coupler disclosed in the aforementioned PCT publication WO2004/112206 to Sintov). For example, the light source can include a plurality of diodes combined using a tapered fiber bundle having an output fiber optically coupled, such as by being spliced, to the MM optical fiber 16. The foregoing arrangements are well known in the art and accordingly are not illustrated herein.

The optical coupling of optical articles (e.g., two optical fibers) can, but need not, include a physical coupling, as is understood by one of ordinary skill in the art. A splice, of course, typically includes a physical coupling. However, it is possible to optically couple without a physical coupling, using, for example, free space transmission techniques.

Accordingly, in one practice of the invention, the light source 70 is coupled so that light having a selected brightness is propagated by the MM optical fiber 16 and, accordingly, the second diameter D₂ is selected such that along the second length 22 the product of the NA of the core of the MM optical fiber 16 and the cross sectional area of the core does not exceed the selected brightness.

In one embodiment of the present invention, a side coupler apparatus 112 can be arranged such that the MM optical fiber 16 is wound with the first optical fiber 14. For example, with reference to FIGS. 1 and 5, at least one of the second length 22 of the MM optical fiber 16 and a selected length 32 of the first optical fiber 14 can wind around the other of the second length 22 of the MM optical fiber 16 and the selected length 32 of the first optical fiber 14. “Wound with” or “wound together”, as used herein, includes one of the optical fibers winding about a substantially straight section of the other of the optical fibers as well as both of the optical fibers being wound such that neither of them is substantially straight where they are wound together.

Optical couplers have received much study over the years and a considerable body of knowledge, both empirical and theoretical, has been amassed regarding determining the optical characteristics of a coupler given its geometrical configuration. In some instances, simple analytic expressions are known. More complex expressions can be solved by well-known computer techniques, and computer techniques are known, whether based on analytic expressions or not, for predicting coupler performance based on the geometric configuration of the coupler, allowing one to find the optimal parameter for a given geometrical design in a given application. Computer techniques are so well known that one of ordinary skill in the art need not write his or her own programs as many commercial software packages are available. See, for example, the RSoft Photonic Suite available from RSoft Design Group, Inc., 400 Executive Boulevard, Suite 100, Ossining, N.Y. 10562. The RSoft Photonic Suite uses RSoft CAD™ as its core program, which acts as a control program for RSoft's passive device simulation modules, including BeamPROP, FullWAVE, BandSOLVE, GratingMOD, and DiffractMOD. See also RSoft's website. This body of work is not reviewed in additional detail here. One of ordinary skill in the art, calling if necessary on this body of work, augmented by appropriate empirical evaluation, can choose coupler parameters, such as, for example, one or more of the selected lengths 32 and 38 and the cross sectional areas A₁, A₂ and A₃, that suit the coupler for a particular application.

Several embodiments of the invention have been described and illustrated herein. Those of ordinary skill in the art will readily envision a variety of other means and structures for performing the functions and/or obtaining the results or advantages described herein and each of such variations or modifications is deemed to be within the scope of the present invention. More generally, those skilled in the art would readily appreciate that all parameters, dimensions, materials and configurations described herein are meant to be exemplary and that actual parameters, dimensions, materials and configurations will depend on specific applications for which the teachings of the present invention are used. It is therefore to be understood that the foregoing embodiments are presented by way of example only and that within the scope of the appended claims and equivalents thereto, the invention may be practiced otherwise than as specifically described.

In the claims as well as in the specification above all transitional phrases such as “comprising”, “including”, “carrying”, “having”, “containing”, “involving” and the like are understood to be open-ended. Only the transitional phrases “consisting of” and “consisting essentially of” shall be closed or semi-closed transitional phrases, respectively, as set forth in the U.S. Patent Office Manual of Patent Examining Procedure §2111.03, 7^{th} Edition, Revision 1.

It is understood that the use of the term “a”, “an” or “one” herein, including in the appended claims, is open ended and means “at least one” or “one or more”, unless expressly defined otherwise. The occasional use of the terms herein “at least one” or “one or more” to improve clarity and to remind of the open nature of “one” or similar terms shall not be taken to imply that the use of the terms “a”, “an” or “one” alone in other instances herein is closed and hence limited to the singular. Similarly, the use of “a part of”, “at least a part of” or similar phrases (e.g., “at least a portion of”) shall not be taken to mean that the absence of such a phrases elsewhere is somehow limiting. For example, consider that it is disclosed that an optical fiber is initially etched along a length and then part or all of the etched length is bonded to a substrate. The phrase “said optical fiber including a length that is etched to have a reduced diameter, at least a part of said etched length bonded to said substrate”, makes it clear that not all of the etched length need be bonded to the substrate. However, the phrase “an optical fiber having an etched length, said etched length being bonded to said substrate”, also is not intended to require that all of the initially etched length be bonded to the substrate, regardless whether or not “at least a part of” is used in similar recitations elsewhere in the specification or claims or not.

Having described the invention, what is claimed as new and to be secured by Letters Patent is:

1. An optical fiber side coupler apparatus, comprising:
a first optical fiber and at least one multimode (MM) optical fiber having a core, said MM optical fiber for delivering light to said first optical fiber;
said MM optical fiber comprising a first length having a first location therealong wherein said core comprises a first cross sectional area A₁, a second length having a second location therealong wherein said core comprises a second cross sectional area A₂ that is less than said first cross sectional area A₁, and a transition section, located between said first and second locations, wherein the cross sectional area of said core of said MM optical fiber is reduced, and
wherein said second length is secured alongside a selected length of said first optical fiber so as to provide optical coupling between said MM optical fiber and said first optical fiber and wherein said MM optical fiber is free of any progressively tapered length secured with said first optical fiber in a manner that would provide substantial optical coupling between said MM optical fiber and said first optical fiber.

2. The optical fiber side coupler apparatus of claim 1 wherein said transition section comprises a length of the MM optical fiber wherein said core thereof comprises a progressive taper.

3. The optical fiber side coupler apparatus of claim 1 wherein said MM optical fiber comprises a third length having a third location therealong wherein said core comprises a third cross sectional area A₃ that is less than said first cross sectional area A₁, and wherein said third length is secured alongside said first optical fiber for providing optical coupling between said MM optical fiber and said first optical fiber.

4. The optical fiber side coupler apparatus of claim 3 wherein said third cross sectional area A₃ is less than said second cross sectional area A₂.

5. The optical fiber side coupler apparatus of claim 4 comprising a second transition section located between said second location and said third location, said second transition section comprising a length of the MM optical fiber wherein said core thereof comprises a progressive taper.

6. The optical fiber side coupler apparatus of claim 3 comprising a second transition section located between said second and third locations, said second transition section being adapted for converting energy from lower order modes of said MM optical fiber to higher order modes of said MM optical fiber.

7. The optical fiber side coupler apparatus of claim 6 wherein said second transition section comprises an up taper and a down taper.

8. The optical fiber side coupler apparatus of claim 1 wherein the cross sectional area of said core of said MM optical fiber remains substantially the same along said second length.

9. The optical fiber side coupler apparatus of claim 1 wherein said second length of said MM optical fiber and said selected length of said first optical fiber are wound together.

10. The optical fiber side coupler apparatus of claim 1 wherein said first optical fiber has an input end and an output end and wherein said second length of said MM optical fiber is secured alongside said selected length of first optical fiber at a location between said input and output ends of said first optical fiber.

11. The optical fiber side coupler apparatus of claim 1 wherein said MM optical fiber has an input end and wherein said optical fiber side coupler apparatus further comprises a light source optically coupled with said input end so that light having a selected brightness is propagated by said MM optical fiber and wherein along the second length the product of the numerical aperture of the core of the MM optical fiber and the cross sectional area of the core does not exceed the selected brightness.

12. The optical fiber side coupler apparatus of claim 1 wherein said first optical fiber comprises a diameter that is substantially the same along said selected length.

13. The optical fiber side coupler apparatus of claim 1 wherein said first optical fiber comprises a cladding pumping optical fiber having a core, an inner cladding disposed about said core and an outer cladding disposed about said inner cladding.

14. The optical fiber side coupler apparatus of claim 13 wherein said outer cladding of said first optical fiber is not present along at least part of said selected length thereof and wherein said cladding of said MM optical fiber is not present along at least part of said second length thereof.

15. The optical fiber side coupler apparatus of claim 13 wherein said inner cladding of said first optical fiber comprises an outer diameter D_{IC} of said inner cladding and said core of said first optical fiber has a diameter D_{CoreCP}, and wherein the first optical fiber comprises a ratio (D²_{IC}/D²_{CoreCP}) of at least 25 at least at a location along a length of said first optical fiber other than a location along said selected length of said first optical fiber.

16. The optical fiber side coupler apparatus of claim 15 wherein said ratio is also at least 25 at a location along said selected length of said first optical fiber.

17. The optical fiber side coupler apparatus of claim 15 wherein said MM optical fiber comprises a cladding disposed about said core of said MM optical fiber, and wherein said core of said MM optical fiber has a diameter D_{CoreMM} and said cladding of said MM optical fiber has a diameter D_{CladMM} and wherein at least at a location along said first length of said MM optical fiber the ratio of (D²_{CladMM}/D²_{coreMM}) is no greater than 1.75.

18. The optical fiber side coupler apparatus of claim 13 wherein at least along said first length said core of said first optical fiber has a numerical aperture of no greater than about 0.09 and a diameter of at least 15 microns for providing a fundamental mode having an increased mode field diameter.

19. The optical fiber side coupler apparatus of claim 18 wherein at least along said first length said core of said first optical fiber has a V-number of greater than 2.5 for light having a wavelength of 1 micron.

20. The optical fiber side coupler apparatus of claim 1 wherein said first transition section includes an up taper and a down taper.
